(19) United States
(12) Patent Application Publication
(10) Pub. No.: US 2026/0333194 A1
(43) Pub. Date: Oct. 22, 2026

(54) UPDATE OF NON-NATIVE NETWORK ACCESS POLICY

(71) Applicant: Nokia Solutions and Networks Oy, Espoo (FI)

(72) Inventors: Bighnaraj PANIGRAHI, Bangalore (IN); Laurent THIÉBAUT, Massy (FR); Georgios GKELLAS, Athens (GR); Bruno LANDAIS, Lannion (FR)

(21) Appl. No.: 19/115,627

(22) PCT Filed: Sep. 22, 2023
(86) PCT No.: PCT/EP2023/076220

§ 371 Date: Mar. 26, 2025

(30) Foreign Application Priority Data
Sep. 30, 2022 (IN) 202241056305

(51) Int. Cl. H04W 48/08; H04W 48/18; H04W 60/00; H04W 92/02

(52) U.S. Cl. CPC H04W 48/08; H04W 48/18; H04W 60/001; H04W 60/002; H04W 92/02

(57) ABSTRACT

Some example embodiments may relate to updating rules of a user equipment. An apparatus may transmit, by an access and mobility management function of a first communication network, to a policy control function of the first communication network, a request for updating policy rules of a user equipment; and request the policy control function to notify when the policy control function has updated the policy rules of the user equipment.

### TECHNICAL FIELD

Various example embodiments generally relate to the field of communication networks. Some example embodiments relate to updating of a non-native network access policy of a device.

### BACKGROUND

A communication network may be operated with multiple network slices, for example to provide several virtualized logical networks within a single physical network. A network slice may be identified by single network slice selection assistance information (S-NSSAI). The communication network may support access via non-native access networks, which may not be standardized by the same entity as the communication network. For example, communication networks based on standards of the 3^{rd} Generation Partnership Project (3GPP) may support non-3GPP access, for example via a non-3GPP inter-working function (N3IWF) or a trusted non-3GPP gateway function (TNGF). Non-native access may be classified as trusted or untrusted, for example depending on whether the non-3GPP access network is managed by the same network operator as the 3GPP network.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable updating non-native network access related policy with appropriate non-native network access functions. This and other benefits may be achieved by the features of the independent claims. Further example embodiments are provided in the dependent claims, the description, and the drawings.

According to a first aspect, an apparatus is disclosed. The apparatus may comprise means for transmitting, by an access and mobility management function of a first communication network, to a policy control function of the first communication network, a request for updating policy rules of a user equipment; and means for requesting the policy control function to notify when the policy control function has updated the policy rules of the user equipment.

According to an example embodiment of the first aspect, the apparatus may comprise: means for receiving, by the access and mobility management function, a registration request from the user equipment for accessing one or more network slices of the first communication network via a second non-3GPP access network; means for determining that a non-3GPP access network already selected by the user equipment does not support the one or more network slices requested by the user equipment; means for transmitting, to the policy control function, the request for updating the policy rules for the user equipment with appropriate non-3GPP access network information; and means for transmitting, to the user equipment, a registration reject message, in response to receiving, from the policy control function, an indication that the policy control function has completed the requested update of the policy rules for the user equipment with appropriate non-3GPP access network information.

According to an example embodiment of the first aspect, the apparatus may comprise: means for determining an appropriate second non-3GPP access network for the user equipment that supports the one or more network slices requested by the user equipment, wherein the registration reject message comprises an indication of the appropriate second non-3GPP access network access function.

According to an example embodiment of the first aspect, the apparatus may comprise: means for receiving, from the policy control function, an indication that the policy control function will proceed with the requested update of the non-3GPP access network access policy of the user equipment; and means for delaying the transmission of the registration reject message until reception of the indication that the policy control function has completed the requested update of the non-3GPP access network access policy of the user equipment.

According to an example embodiment of the first aspect, the first communication network comprises a 3GPP core network.

According to an example embodiment of the first aspect, the second non-3GPP access network comprises a trusted or an untrusted non-3GPP access network to a 3GPP core network.

According to an example embodiment of the first aspect, the non-3GPP access network access policy of the user equipment comprises an access network discovery and selection policy or a wireless local area network selection policy.

According to an example embodiment of the first aspect, the second non-3GPP access network comprises a non-3GPP interworking function (N3IWF) or a trusted non-3GPP gateway function (TNGF).

According to an example embodiment of the first aspect, the apparatus may comprise: means for sending the registration reject message to the user equipment, in response to determining that the apparatus has not received on time a notification that the user equipment has received the requested update of the non-3GPP access network access policy.

According to a second aspect, as method is disclosed. The method may comprise: transmitting, by an access and mobility management function of a first communication network, to a policy control function of the first communication network, a request for updating policy rules of a user equipment; and requesting the policy control function to notify when the policy control function has updated the policy rules of the user equipment.

According to an example embodiment of the second aspect, the method may comprise: receiving, by the access and mobility management function, a registration request from the user equipment for accessing one or more network slices of the first communication network via a second non-3GPP access network; determining that a non-3GPP access network already selected by the user equipment does not support the one or more network slices requested by the user equipment; transmitting, to the policy control function, the request for updating the policy rules for the user equipment with appropriate non-3GPP access network information; and transmitting, to the user equipment, a registration reject message, in response to receiving, from the policy control function, an indication that the policy control function has completed the requested update of the policy rules for the user equipment with appropriate non-3GPP access network information.

According to an example embodiment of the second aspect, the method may comprise: determining an appropriate second non-3GPP access network for the user equipment that supports the one or more network slices requested by the user equipment, wherein the registration reject message comprises an indication of the appropriate second non-3GPP access network access function.

According to an example embodiment of the second aspect, the method may comprise: receiving, from the policy control function, an indication that the policy control function will proceed with the requested update of the non-3GPP access network access policy of the user equipment; and delaying the transmission of the registration reject message until reception of the indication that the policy control function has completed the requested update of the non-3GPP access network access policy of the user equipment.

According to an example embodiment of the second aspect, the first communication network comprises a 3GPP core network.

According to an example embodiment of the second aspect, the second non-3GPP access network comprises a trusted or an untrusted non-3GPP access network to a 3GPP core network.

According to an example embodiment of the second aspect, the non-3GPP access network access policy of the user equipment comprises an access network discovery and selection policy or a wireless local area network selection policy.

According to an example embodiment of the second aspect, the second non-3GPP access network comprises a non-3GPP interworking function (N3IWF) or a trusted non-3GPP gateway function (TNGF).

According to an example embodiment of the second aspect, the method may comprise: sending the registration reject message to the user equipment, in response to determining that the apparatus has not received on time a notification that the user equipment has received the requested update of the non-3GPP access network access policy.

According to a third aspect, a computer program or a computer program product is disclosed. The computer program or computer program product may comprise instructions for causing an apparatus to perform at least the following: transmitting, by an access and mobility management function of a first communication network, to a policy control function of the first communication network, a request for updating policy rules of a user equipment; and requesting the policy control function to notify when the policy control function has updated the policy rules of the user equipment. The computer program or the computer program product may comprise instructions for causing an apparatus to perform any example embodiment of the method of the second aspect.

According to a fourth aspect, an apparatus is disclosed. Apparatus may comprise at least one processor; and at least one memory storing instructions that, when executed by the at least one processor, cause the apparatus at least to: transmit, by an access and mobility management function of a first communication network, to a policy control function of the first communication network, a request for updating policy rules of a user equipment; and request the policy control function to notify when the policy control function has updated the policy rules of the user equipment. The instructions, when executed by the at least one processor, may further cause the apparatus to perform any example embodiment of the method of the second aspect.

According to a fifth aspect, an apparatus is disclosed. The apparatus may comprise means for receiving, by a policy control function of a first communication network, a request for updating policy rules of a user equipment; means for updating the policy rules of the user equipment; and means for transmitting, to an access and mobility management function of the first communication network, an indication that the policy control function has completed the requested update of the policy rules of the user equipment.

According to an example embodiment of the fifth aspect, the apparatus may comprise: means for receiving, by the policy control function, a request for indicating when the policy rules of the user equipment have been updated.

According to an example embodiment of the fifth aspect, the apparatus may comprise: means for receiving, by the policy control function, a request for updating a non-3GPP access network access policy of the user equipment comprising an indication of an appropriate non-3GPP access network access function to be included in the non-3GPP access network access policy of the user equipment, and a request for indicating when said policy rules have been updated on said user equipment; means for updating the non-3GPP access network access policy of the user device to include the indicated appropriate non-3GPP access network access function; and means for transmitting, to the access and mobility management function, an indication that the policy control function has completed the requested update of the non-3GPP access network access policy of the user equipment.

According to an example embodiment of the fifth aspect, the apparatus may comprise: means for determining that the policy control function will proceed with the requested update of the non-3GPP access network access policy of the user equipment; and means for transmitting, to the access and mobility management function, an indication that the policy control function will proceed with the requested update of the non-3GPP access network access policy of the user equipment.

According to an example embodiment of the fifth aspect, the first communication network comprises a 3GPP core network.

According to an example embodiment of the fifth aspect, the non-3GPP access network comprises a trusted or untrusted non-3GPP access network to a 3GPP core network.

According to an example embodiment of the fifth aspect, the non-3GPP access network access policy of the user equipment comprises an access network discovery and selection policy or a wireless local area network selection policy.

According to an example embodiment of the fifth aspect, the first communication network comprises a non-3GPP interworking function or a trusted non-3GPP gateway function.

According to a sixth aspect, a method is disclosed. The method may comprise: receiving, by a policy control function of a first communication network, a request for updating policy rules of a user equipment; updating the policy rules of the user equipment; and transmitting, to an access and mobility management function of the first communication network, an indication that the policy control function has completed the requested update of the policy rules of the user equipment.

According to an example embodiment of the sixth aspect, the method may comprise: receiving, by the policy control function, a request for indicating when the policy rules of the user equipment have been updated.

According to an example embodiment of the sixth aspect, the method may comprise: receiving, by the policy control function, a request for updating a non-3GPP access network access policy of the user equipment comprising an indication of an appropriate non-3GPP access network access function to be included in the non-3GPP access network access policy of the user equipment, and a request for indicating when said policy rules have been updated on said user equipment; updating the non-3GPP access network access policy of the user device to include the indicated appropriate non-3GPP access network access function; and transmitting, to the access and mobility management function, an indication that the policy control function has completed the requested update of the non-3GPP access network access policy of the user equipment.

According to an example embodiment of the sixth aspect, the method may comprise: determining that the policy control function will proceed with the requested update of the non-3GPP access network access policy of the user equipment; and transmitting, to the access and mobility management function, an indication that the policy control function will proceed with the requested update of the non-3GPP access network access policy of the user equipment.

According to an example embodiment of the sixth aspect, the first communication network comprises a 3GPP core network.

According to an example embodiment of the sixth aspect, the non-3GPP access network comprises a trusted or untrusted non-3GPP access network to a 3GPP core network.

According to an example embodiment of the sixth aspect, the non-3GPP access network access policy of the user equipment comprises an access network discovery and selection policy or a wireless local area network selection policy.

According to an example embodiment of the sixth aspect, the first communication network comprises a non-3GPP interworking function or a trusted non-3GPP gateway function.

According to a seventh aspect, a computer program or a computer program product is disclosed. The computer program or computer program product may comprise instructions for causing an apparatus to perform at least the following: receiving, by a policy control function of a first communication network, a request for updating policy rules of a user equipment; updating the policy rules of the user equipment; and transmitting, to an access and mobility management function of the first communication network, an indication that the policy control function has completed the requested update of the policy rules of the user equipment. The computer program or the computer program product may comprise instructions for causing an apparatus to perform any example embodiment of the method of the sixth aspect.

According to an eighth aspect, an apparatus is disclosed. Apparatus may comprise at least one processor; and at least one memory storing instructions that, when executed by the at least one processor, cause the apparatus at least to: receive, by a policy control function of a first communication network, a request for updating policy rules of a user equipment; update the policy rules of the user equipment; and transmit, to an access and mobility management function of the first communication network, an indication that the policy control function has completed the requested update of the policy rules of the user equipment. The instructions, when executed by the at least one processor, may cause the apparatus to perform any example embodiment of the method of the sixth aspect.

Any example embodiment may be combined with one or more other example embodiments. These and other aspects of the present disclosure will be apparent from the example embodiment(s) described below. Computer program(s) may be stored on a (non-transitory) computer readable medium, for example as program instructions stored thereon for performing, or causing performance by an apparatus of, any example embodiment of the method(s) disclosed herein.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a communication network;

FIG. 2 illustrates an example of an apparatus configured to practice one or more example embodiments;

FIG. 3 illustrates examples of example of a message sequence and operations for connecting to a 3GPP network via a non-3GPP access network;

FIG. 4 illustrates an example of a method for requesting update a non-native network access policy of a device; and

FIG. 5 illustrates an example of a method for updating a non-native network access policy of a device.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

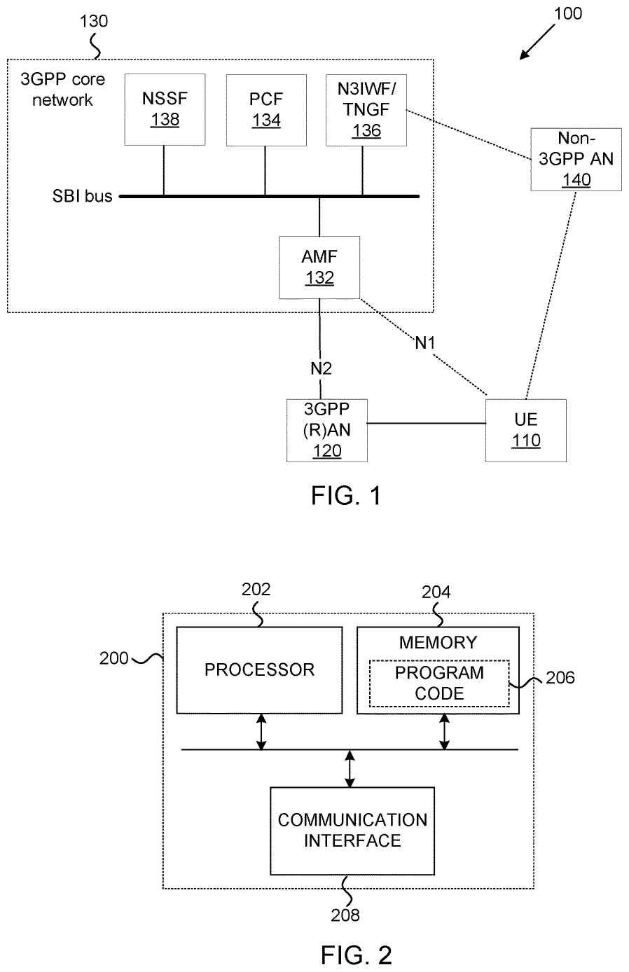

FIG. 1 illustrates an example of a communication network. A device, represented in this example by user equipment (UE) 110 may access application services via a 3GPP (radio) access network, (R)AN 120. RAN 120 may comprise one or more access nodes (AN), for example, 5G access nodes (gNB). UE 110 may communicate with the access nodes over a radio interface, configured for example based on the 3GPP 5G NR (New Radio). A 3GPP non-radio access network may comprise a non-3GPP inter-working function (N3IWF) or trusted non-3GPP gateway function (TNGF) 136. A core network of communication network 100, represented in this example by 3GPP core network 130, may be implemented with various network functions, such as for example an access and mobility management function (AMF) 132, a policy control function (PCF) 134, a network slice selection function (NSSF) 138, or the like. The network functions may communicate with each other, for example over the service based interface (SBI) bus of the 3GPP 5G core network. Communication network 100 may comprise other network function(s), in addition, or alternative to, the network functions illustrated in FIG. 1. Alternatively, 3GPP core network 130 may be accessed by UE 110 via a non-3GPP access network 140, for example a Wi-Fi network.

Even though some embodiments have been described in the context of 3GPP and non-3GPP networks, it is appreciated that embodiments of the present disclosure are not limited to such example. Example embodiments may be therefore applied in any present or future communication networks, where access to the network may be enabled over various types of access networks, for example non-native access network (e.g., Wi-Fi) configured to supplement radio access via a native access network (e.g. RAN 120) communication network 100.

AMF 132 may be configured to receive connection and session request from UE 110 (via an access node of the RAN 120 or a non-3GPP inter-working function (N3IWF) or trusted non-3GPP gateway function (TNGF) 136), for example, over the N1 and N2 interfaces. AMF 132 may control connection and mobility management in communication network 100. PCF 134 may be configured to manage communication session management related policy rules and provide them as policy and charging control (PCC) rules to other network function(s) to enforce the rules.

A N3IWF may be applied in case of untrusted non-3GPP access, for example via an access point of a wireless local area network (WLAN), e.g., Wi-Fi. N3IWF may provide a secure gateway to the 3GPP core network for non-3GPP access. A TNGF may be applied to provide similar functionality in case of trusted non-3GPP access.

NSSF 138 may provide assistance to AMF 132 with selection of network slice(s) for serving UE 110. NSSF 138 may for example determine allowed NSSAI(s) that may be supplied to UE 110. Furthermore, NSSF 138 may allocate another AMF for UE 110, for example if the current AMF 132 is not able to support all network slice instances for UE 110.

An apparatus may comprise, or be configured to implement, e.g. by means of software, one or more of the network functions described herein.

In accordance with illustrative example embodiments described in context of 5GS environment, one or more 3GPP technical specifications (TS) and technical reports (TR) may provide further explanation of network elements/functions and/or operations that may interact with parts of the solutions described herein. However, while well-suited for 5G-related 3GPP standards, embodiments are not necessarily intended to be limited to any particular standards.

Example embodiments of the present disclosure may enable network slice based selection or re-selection of N3IWF/SSID(TNGF) 136 by UE 110 during registration of UE 110 via non-3GPP access network 140. N3IWF/SSID(TNGF) refers to the fact that the UE selects a N3IWF but indirectly selects a TNGF via the SSID the UE 110 has used to request Trusted access to 3GPP Core network. The following scenarios may be considered:
UE based selection: UE 110 may discover and select an appropriate N3IWF/TNGF 136 by connecting to an appropriate access point (AP) or trusted non-3GPP access point (TNAP) of non-3GPP access network 140, or with an appropriate service set identifier (SSID) of non-3GPP access network 140, that is able to satisfy the S-NSSAI(s) needs of UE 110. UE 110 may then register to the 3GPP core network (e.g. 5G system, 5GS) via the selected N3IWF or via the TNGF determined based on the service set identifier (SSID) selected by the UE.
Network based selection: AMF 132 may be aware of the network slices supported by different N3IWF(s)/TNGF(s), for example because an N2 setup request sent from N3IWF/TNGF 136 to AMF 132 may include an indication of tracking area identifier(s) (TAI) supported by N3IWF/TNGF 136 and S-NSSAI(s) supported on the indicated TAI(s). Based on the information on the S-NSSAI(s) supported by N3IWF/TNGF 136, AMF 132 may determine that UE 110 has selected an inappropriate N3IWF/TNGF with respect to the required S-NSSAI(s). AMF 132 may therefore reject the associated registration request of UE 110. Additionally, AMF 132 may transmit an indication of an appropriate target N3IWF/TNGF to UE 110, for example in a registration reject message.

An N3IWF/TNGF 136 selected by UE 110 for connecting to 3GPP core network 130 may not be appropriate for example for one or more of the following reasons:
UE 110 may have selected SSID/TNGF or N3IWF that does not support the S-NSSAI(s) requested by UE 110. For example, UE 110 may have selected the SSID/N3IWF/TNGF using an obsolete WLANSP (WLAN selection policy) or ANDSP (Access network discovery & selection policy) configuration.
UE 110 may have selected SSID/N3IWF/TNGF that only partially supports the S-NSSAI(s) requested by UE 110. For example, UE 110 may have requested support for five S-NSSAIs, but the selected SSID/N3IWF/TNGF only supports two out of them.
UE 110 may have selected some SSID/TNGF or N3IWF according to certain network slice(s), but UE 110 may not (or no more) be allowed to use those network slice(s), for example public safety network slices.
UE 110 may have selected a SSID supported by a TNGF, but the TNGF supports different SSIDs for different S-NSSAIs and the S-NSSAI(s) requested by UE 110 can not be served by the SSID selected by UE 110.

When AMF 132 determines that UE 110 has selected an inappropriate N3IWF/TNGF 136 and finds out an appropriate target N3IWF/SSID(TNGF) for UE 110, it may be desired to inform PCF 134 accordingly, such that PCF 134 is triggered to update the UE policy rules within the UE 110. Also, it may not be desired to transmit a registration reject message by AMF 132 to UE 110 before PCF 134 has updated the UE policies for UE 110. However, AMF 132 may not be generally aware of when/whether PCF 134 has updated the UE policy rules within the UE 110. A registration reject message sent before UE policy update may therefore cause UE 110 to be left with an obsolete policy set.

According to example embodiments of the present disclosure, AMF 132 may trigger a UE policy association establishment procedure to provide UE 110 with updated N3IWF/SSID(TNGF) selection information. Furthermore, AMF 132 may be configured to wait until it gets feedback from PCF 136 on completion of the update of UE policies. AMF 132 may delay sending the registration reject message to UE 110 until receiving the feedback from PCF 136.

FIG. 2 illustrates an example of an apparatus 200 configured to practice one or more embodiments. Apparatus 200 may comprise a network device implementing one or more network functions, or in general a device configured to implement functionality described herein. Apparatus 200 may comprise at least one processor 202. The at least one processor 202 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The memory 204 may be configured to store, for example, computer program code or the like, for example operating system software and application software. The memory 204 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.). Memory 204 is provided as an example of a (non-transitory) computer readable medium.

Apparatus 200 may further comprise a communication interface 208 configured to enable apparatus 200 to transmit and/or receive information. The communication interface 208 may comprise an internal communication interface such as for example an interface (e.g. SBI) between different network functions of the apparatus 200. Apparatus 200 may further comprise other components and/or functions such as for example a user interface (not shown) comprising at least one input device and/or at least one output device. The input device may take various forms such a keyboard, a touch screen, or one or more embedded control buttons. The output device may for example comprise a display, a speaker, or the like.

When apparatus 200 is configured to implement some functionality, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as software components. According to an example embodiment, apparatus 200 comprises a processor or processor circuitry, such as for example a microcontroller, configured by the program code 206, when executed, to execute the embodiments of the operations and functionality described herein. Program code 206 is provided as an example of instructions which, when executed by the at least one processor 202, cause performance of apparatus 200.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

Apparatus 200 may be configured to perform method(s) described herein or comprise means for performing method(s) described herein. In one example, the means comprises the at least one processor 202, the at least one memory 204 including program code 206 (computer program instructions) configured to, when executed by the at least one processor 202, cause apparatus 200 to perform the method(s). In general, computer program instructions may be executed on means providing generic processing functions. Such means may be embedded for example in a network device, a server, or the like. The method(s) may be thus computer-implemented, for example based algorithm(s) executable by the generic processing functions, an example of which is the at least one processor 202. The means may comprise transmission or reception means, for example one or more radio transmitters or receivers, which may be coupled or be configured to be coupled to one or more antennas, or transmitter(s) or receiver(s) of a wired communication interface.

Apparatus 200 may comprise, for example, a network device, for example, a server, a base station, or the like. Although apparatus 200 is illustrated as a single device, it is appreciated that, wherever applicable, functions of apparatus 200 may be distributed to a plurality of devices.

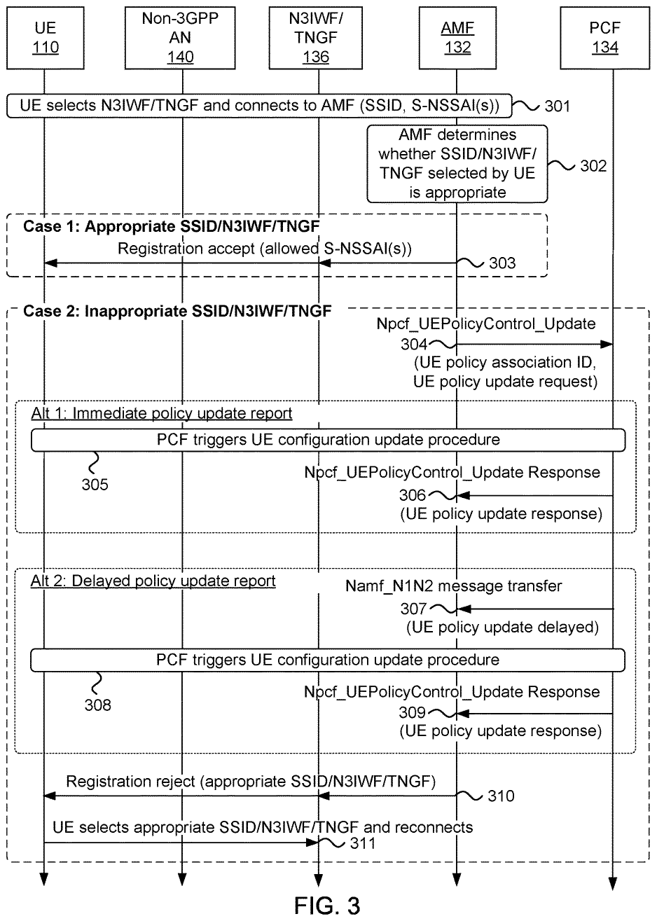

FIG. 3 illustrates examples of example of a message sequence and operations connecting to a 3GPP network via a non-3GPP access network. Even though network functions of the 3GPP core network and non-3GPP access are used as examples, it is appreciated that the functionality described herein may be generally applied to any communication network that enables access via a non-native access network (e.g., non-3GPP access, for example via WLAN). For example, functionality of N3IWF/TNGF 136 may be generally provided by a non-native network access function, functionality of AMF 132 may be generally provided at an access management function of the (native) communication network, and functionality of PCF 134 may be generally provided at any network function controlling non-native network access policy of UE 110, which is provided as an example of a device.

At operation 301, UE 110 may select N3IWF/SSID(TNGF) 136, which represent examples of a non-native network access function. UE 110 may connect to AMF 132. UE 110 may select N3IWF/SSID(TNGF) 136 based on non-3GPP access policy of UE 110. The selected N3IWF/SSID(TNGF) 136 may support certain network slice(s) for UE 110, identified for example by respective S-NSSAI(s). N3IWF/SSID(TNGF) 136 may support different network slices for different UEs. For example, UE 110 may not be allowed to use some network slice(s), for example public safety network slices, even if those network slice(s) were supported for other UE(s), e.g., for public safety applications.

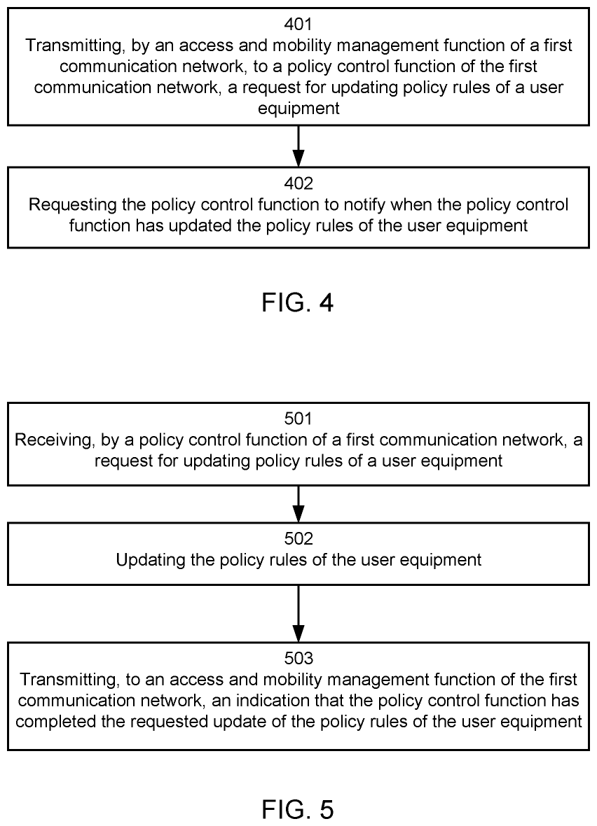

In case of N3IWF, operation 301 may be carried out for example as described in Steps 1 to 8 illustrated in FIG. 4.12.2.2-1 of 3GPP TS 23.502 V17.6.0 (2022 Sep.), which is incorporated herein by reference. In case of TNGF, operation 301 may be carried out for example as described in Steps 0 to 8 illustrated in FIG. 4.12a.2.2.1-1 of 3GPP TS 23.502 V17.6.0 (2022 Sep.).

The following procedure may be applied in case of untrusted non-3GPP access. UE 110 may connect to an untrusted non-3GPP access network with any appropriate authentication procedure. An IP address may be assigned to UE 110. When UE 110 determines to attach to 3GPP core network 130, for example the 5G core network (5GC), UE 110 may select an N3IWF. UE 110 may proceed with establishment of an IPsec security association (SA) with the selected N3IWF, for example by initiating an internet key exchange (IKE) initial exchange. During the IKE authentication, UE 110 may transmit to N3IWF access network parameters and/or a registration request message. The access network parameters may contain information for use by the N3IWF for selecting an AMF, for example the global unique AMF identifier (ID), the selected public land mobile network (PLMN) ID, identifier(s) of the requested network slices (NSSAI), or an establishment cause. The establishment cause may indicate reason for requesting the signalling connection with 3GPP core network 130. The N3IWF may select AMF 132 based on the received access network parameters and/or a local policy. The N3IWF may forward the registration request received from UE 110 to AMF 132, for example within an N2 interface message. This message may contain N2 parameters, for example including the selected PLMN ID and the establishment cause. AMF 132 may request a subscription concealed identifier of UE 110, for example by sending a non-access stratum (NAS) identity request message to UE 110. AMF 132 may then authenticate UE 110, for example by invoking an authentication server function (AUSF) of 3GPP core network 130.

The following procedure may be applied in case of trusted non-3GPP access. UE 110 may select a PLMN and a trusted non-3GPP access network (TNAN) for connecting to the selected PLMN. UE 110 may discover the PLMNs with which the TNAN supports trusted connectivity (e.g., 5G connectivity). When the trusted non-3GPP access comprises trusted WLAN access, UE 110 may be configured (e.g. with WLANSP rules) to select an SSID which supports one or more of the S-NSSAI(s) subscribed by UE 110. Based on the SSID selected by the UE 110, a corresponding TNGF is determined to connect the UE 110 to the 3GPP Core network. A layer-2 connection may be established between UE 110 and an access point of the TNAN. An extensible authentication protocol (EAP) may be initiated. The EAP procedure may include generation of a TNGF key in UE 110 and in AMF 132 after successful authentication. The TNGF key may be transferred from AMF 132 to the TNGF, for example within an N2 initial context setup request. UE 110 may transmit, to the TNGF, a registration request comprising, or being associated with, an indication of the network slice(s) requested by UE 110 (requested NSSAI), for example as part of access network parameters. UE 110 may also include its UE ID, for example a 5G-GUTI (5G global unique temporary identifier), in the access network parameters, for example if it is available from a prior registration to the same PLMN. The TNFG may perform AMF selection, for example to select AMF 132. The TNGF may forward the registration request of UE 110 to AMF 132.

Operation 301 may therefore include receiving, by AMF 132, a registration request of UE 110. AMF 132 may receive the registration request from UE 110, for example via non-3GPP access network 140 and the selected N3IWF/SSID(TNGF) 136. The request may be transmitted for accessing 3GPP core network 130, for example particular network slice(s) of 3GPP core network 130. The request may be received via non-3GPP access network 140. 3GPP core network 130 may be also referred to as a first communication network and non-3GPP access network 140 may be referred to as a second non-3GPP access network. The request may comprise, or be associated with, an indication of the requested network slice(s), e.g., by means of respective S-NSSAI(s). UE 110 may connect to an access point of non-3GPP access network 140, which has a particular SSID.

At operation 302, AMF 132 may determine whether SSID or N3IWF/TNGF already selected by UE 110 is/are appropriate. For example, AMF 132 may determine whether N3IWF/SSID(TNGF) 136 (first non-native network access function) selected by UE 110 supports the network slice(s) requested by UE 110. In other words, AMF 132 may determine whether the SSID/TNGF or N3IWF used by UE 110 to contact 3GPP core network is appropriate or not. AMF 132 may determine this using other network function(s), such as for example NSSF 138, or use information received from N3IWF/TNGF 136, for example over an NGAP (next generation application protocol) interface. Any suitable method for determining whether the SSID/TNGF/N3IWF are appropriate may be used.

For example, AMF 132 may determine that the N3IWF/SSID(TNGF) 136 selected by UE 110 does not support the requested network slice(s) based on one or more of the following:
determining that the access point of non-3GPP access network 140 (identified by the SSID) and/or N3IWF/TNGF 136 does not support the requested S-NSSAI(s),
determining that the access point of non-3GPP access network 140 and/or N3IWF/TNGF 136 supports only a subset of the requested S-NNSAI(s),
determining that UE 110 is not allowed to use the requested network slice(s), or
determining that UE 110 has selected an SSID supported by the TNGF, but TNGF 136 does not support the requested S-NSSAI(s) for that SSID, for example because the TNGF may be configured to support different S-NSSAI(s) for different SSID(s).

AMF 132 may determine that the SSID/N3IWF/TNGF is/are appropriate if the requested S-NSSAI(s) are supported by the SSID/N3IWF/TNGF.

AMF 132 may further determine at least on one other N3IWF/SSID(TNGF) (second non-native network access function) for UE 110 for accessing the network slice requested by UE 110. The at least one other N3IWF/SSID(TNGF) may support accessing the requested network slice for UE 110.

The procedure subsequent to operation 302 may be divided into following cases:
Case 1: Appropriate SSID/N3IWF/TNGF, and
Case 2: Appropriate SSID/N3IWF/TNGF, including the alternatives of immediate (Alt 1) and delayed (Alt 2) policy update reports by PCF 134.

In Case 1, operation 303 may include AMF 132 transmitting to UE 110 a registration acceptance message. The registration acceptance message may be transmitted in response to determining, e.g., by AMF 132, that N3IWF/SSID(TNGF) 136 selected by UE 110 for accessing the 3GPP core network 130 is appropriate, e.g., supports the network slice(s) requested by UE 110. The registration acceptance message may comprise an indication of the network slices allowed or supported for UE 110, e.g., by means of respective S-NNSAI(s).

In Case 2, operation 304 may include AMF 132 transmitting, to PCF 134, a request for updating the non-3GPP access policy of UE 110. This may be done to request PCF 134 to add the other (appropriate) N3IWF/SSID(TNGF) to the non-3GPP access policy of UE 110. AMF 132 may trigger a UE PCF policy create or update procedure, using for example Npcf_UEPolicyControl_Create or Npcf_UEPolicyControl_Update message to request PCF 134 to update UE 110 with appropriate policies, for example access network discovery and selection policy (ANDSP) and/or wireless local area network selection policy (WLANSP) for non-3GPP access to 3GPP core network 130. Updating PCF 134 with the new N3IWF(s)/TNGF(s) of UE 110 enables subsequent policy control procedures to be performed with appropriate N3IWF(s)/TNGF(s) for UE 110.

The request for updating the non-3GPP access policy of UE 110 may include a UE policy association ID. The request may be transmitted for updating policy rules of/on UE 110, for example with appropriate non-3GPP access network information (e.g., appropriate N3IWF(s)/TNGF(s) supporting the requested network slice(s)). The request may comprise an indication of the appropriate N3IWF(s)/TNGF(s).

AMF 132 may transmit, to PCF 134, a request for indicating that PCF 134 has completed the requested update of the non-3GPP access policy of UE 110. In other words, AMF 132 may request PCF 134 to notify (e.g. AMF 132) when PCF 134 has updated the policy rules of/on UE 110. For example, AMF 132 may transmit, for example included in the request for the update, a parameter requesting PCF 134 to report whether/when PCF 134 has updated the non-3GPP access policy for UE 110. AMF 132 may for example issue a subscription to the completion of the requested update of the non-3GPP access policy, including for example ANDSP and/or WLANSP.

In the first alternative (Alt 1) of Case 2, PCF 134 may provide an immediate policy update report to AMF 132. PCF 134 may update UE policy information and respond to AMF 132 about the successful completion of this update.

At operation 305, PCF 134 may trigger a UE configuration update procedure, for example as defined in clause 4.2.4.3 of 3GPP TS 23.502 V17.6.0 (2022 Sep.).

PCF 134 may initiate the UE configuration update procedure, for example in response determining to update UE policy (e.g. non-3GPP access policy) in UE configuration of UE 110. PCF 134 may determine to update the UE policy based on triggering conditions such as for example an initial registration or registration with 5GC when UE 110 moves from the evolved packet core (EPC) of 4G to 5GC. If PCF 134 has not subscribed to be notified by AMF 132 about UE response to an update of UE policy information, PCF 134 may subscribe to AMF 132 to be notified about the UE response to an update of UE policy information. PCF 134 may invoke a Namf_Communication_N1N2MessageTransfer service operation provided by AMF 132. This message may include the subscription permanent identifier (SUPI) of UE 110 and/or a UE policy container. If UE 110 is registered and reachable by AMF 132, in either 3GPP access or non-3GPP access, AMF 132 may transfer the UE policy container to UE 110. The UE policy container may include the non-3GPP access policy (e.g. ANDSP and/or WLANSP) of UE 110. UE 110 may update the UE policy provided by PCF 134 and send a result of the update to AMF 132. AMF 132 may forward the response of UE 110 to PCF 134, using for example Namf_Communication_N1MessageNotify message. PCF 134 may maintain a latest list of policy section identifiers (PSI) delivered to UE 110 and update the latest list of PSIs in a user data repository (UDR) function of 3GPP core network 130, for example by invoking a Nudr_DM_Update service operation. If PCF 134 is notified about a UE policy delivery failure from AMF 132, PCF 134 may initiate a UE policy association modification procedure to provide a trigger “connectivity state changes” in a policy control request trigger of UE policy association to AMF 132. PCF 134 may re-initiate the UE configuration update procedure for transparent UE policy delivery, for example in response to being notified of a UE connectivity state change to CONNECTED.

Therefore, during this operation, PCF 134 may update the non-3GPP access policy of UE 110, for example to include the N3IWF/SSID(TNGF) 136 indicated by AMF 132 at operation 304.

At operation 306, PCF 134 may transmit to AMF 132 an indication that PCF 134 has completed the requested update of the non-3GPP access policy of UE 110. Hence, in response to completion of the requested update, PCF 132 may respond to AMF 132 and inform AMF 132 about the success of the UE policy update, for example with a notification based on the subscription made by AMF 132. PCF 134 may for example use a Npcf_UEPolicyControl_Update Response message for transmitting this indication. The Npcf_UEPolicyControl_Update Response may comprise a UE policy update response field indicative of the completion of the requested update. The indication of PCF 134 having completed the requested update may be transmitted, in response to the request, received from AMF 132, to indicate whether/when PCF 134 has completed the requested update. Transmitting the registration reject message to UE 110, including the information about appropriate N3IWF(s)/TNGF(s), after completion of the requested non-3GPP access policy update enables the 3GPP core network 130 to be prepared for future registration requests or other non-3GPP access related tasks for UE 110. For example, UE 110 may be prevented from making further registration requests via the indicated appropriate N3IWF(s)/TNGF(s) before the associated policies have been successfully configured at PCF 134.

The second alternative (Alt 1) of Case 2 may be related to scenarios, where PCF 134 experiences a delay in sending the updated policies to UE, for example because unexpectedly long time being used to exchanging/signalling the relevant information. In such a case, AMF 132 may keep waiting for a response from PCF 134, possibly experiencing an associated timeout and retrying sending the request for the update, without knowing whether the update of the non-3GPP policy by PCF 134 was successful or whether it failed. Therefore, PCF 134 may be configured to indicate, for example in a response to the subscription by AMF 132, that the update of non-3GPP access policy for UE 110 is getting delayed. PCF 134 may subsequently inform AMF 132 once it has completed the update procedure, for example sending a notification associated with subscription by AMF 132.

At operation 307, PCF 134 may determine (e.g. estimate) that there is a delay associated with the requested update of the non-3GPP access policy of UE 110. PCF 134 may transmit, to AMF 132, an indication of the delay of the requested update. This indication (‘UE policy update delayed’) may be transmitted for example using a Namf_N1N2MessageTransfer message.

At operation 308, PCF 134 may trigger a UE configuration update procedure, similar to operation 305. However, AMF 132 may delay transmission of a registration reject message (cf. operation 310) until reception of the indication of the completion of the requested update by PCF 134. Transmission of the registration reject message may be delayed, in response to receiving the indication of the delay in updating the non-3GPP access policy of UE 110 (cf. operation 307). This may be done for example if AMF 132 had requested PCF 132 to indicate the completion of the requested update, for example by setting an associated parameter in the request for updating the non-3GPP access policy of UE 110 (cf. operation 304).

At operation 309, PCF 134 may transmit to AMF 132 an indication that PCF 134 has completed the requested update of the non-3GPP access policy of UE 110, similar to operation 306. However, PCF 134 may transmit this indication with some delay, as determined at operation 307.

At operation 310, AMF 132 may transmit a registration reject message to UE 110 (e.g., via N3IWF/TNGF 136 and non-3GPP access network 140). Transmission of the registration request message may be in response to receiving, e.g., from PCF 132, the indication that PCF 134 has completed the requested update of the non-3GPP access policy of UE 110. The registration reject message may comprise an indication of appropriate SSID/N3IWF/TNGF, for example the other N3IWF(s)/TNGF(s) determined to support the network slice(s) requested by UE 110. In other words, after receiving a response indicative of a successful update of the UE policy from PCF 134, AMF 132 may send the registration reject message towards UE 110. Optionally, AMF 132 may also include the appropriate SSID/N3IWF/TNGF information in the registration reject message. Appropriate (target) TNGF/N3IWF information may include a fully qualified domain name (FQDN) and/or IP address of the appropriate TNGF/N3IWF.

Generally, and particularly for both alternatives (Alt 1 and Alt2) for Case 2, AMF 132 may start a timer when sending to PCF 134 the request for indicating that PCF 134 has completed the requested update of the non-3GPP access policy of UE 110. Then, in case AMF 132 does not receive any response/indication that PCF 134 has completed the requested update of the non-3GPP access policy of UE 110, AMF 132 may be configured to send to UE 110 the registration reject message (see operation 310), when the respective timer expires or has expired.

The registration reject message may be sent to UE 110, in response to determining, by AMF 132, that AMF 132 (or a network device comprising AMF 132) has not received on time, e.g., by an expected time, a notification that the UE 110 has received the requested update of the non-3GPP access network access policy.

At operation 311, UE 110 may select appropriate SSID/N3IWF/TNGF, for example a N3IWF/SSID(TNGF) indicated by AMF 132 in the registration reject message of operation 310, and reconnect to 3GPP core network 130 via the appropriate N3IWF/TNGF. When doing so, UE 110 may use the non-3GPP access policy (e.g. ANDSP and/or WLANSP) updated by PCF 134 to reconnect via the appropriate N3IWF/TNGF.

FIG. 4 illustrates an example of a method for requesting update a non-native network access policy of a device

At 401, the method may comprise transmitting, by an access and mobility management function of a first communication network, to a policy control function of the first communication network, a request for updating policy rules of a user equipment.

At 402, the method may comprise requesting the policy control function to notify when the policy control function has updated the policy rules of the user equipment.

FIG. 5 illustrates an example of a method for updating a non-native network access policy of a device.

At 501, the method may comprise receiving, by a policy control function of a first communication network, a request for updating policy rules of a user equipment.

At 502, the method may comprise updating the policy rules of the user equipment.

At 503, the method may comprise transmitting, to an access and mobility management function of the first communication network, an indication that the policy control function has completed the requested update of the policy rules of the user equipment.

Further features of the methods directly result from the functionality of the network function(s) described throughout the description, claims, and drawings, and are therefore not repeated here. An apparatus, such as for example a network device configured to implement one or more network functions, may be configured to perform or cause performance of any aspect of the method(s) described herein. Further, a computer program or a computer program product may comprise instructions for causing, when executed, a device to perform any aspect of the method(s) described herein. Further, a device may comprise means for performing any aspect of the method(s) described herein. According to an example embodiment, the means comprises at least one processor, and memory including program code or instructions which, the at least one processor, and program code when executed by the when executed by the at least one processor, cause an apparatus to perform any aspect of the method(s).

Alternatively, method describe herein may be characterized by the following numbered clauses:
Clause 1: A method comprising: receiving, by an access management function of a communication network, a registration request of a device for accessing a network slice of the communication network via a non-native access network; determining that a first non-native network access function selected by the device does not support the network slice for the device; determining a second non-native network access function for the device for accessing the network slice requested by the device; transmitting, to a policy control function of the communication network, a request for updating a non-native network access policy of the device to include the second non-native network access function; and transmitting, to the device, a registration reject message, in response to receiving, from the policy control function, an indication that the policy control function has completed the requested update of the non-native network access policy of the device.
Clause 2: The method according to clause 1, wherein the registration reject message comprises an indication of the second non-native network access function.
Clause 3: The method according to clause 1 or 2, further comprising: transmitting, to the policy control function, a request for indicating that the policy control function has completed the requested update of the non-native network access policy of the device.
Clause 4: The method according to any of clauses 1 to 3, further comprising: receiving, from the policy control function, an indication of a delay of the requested update of the non-native network access policy of the device; and delaying the transmission of the registration reject message until reception of the indication that the policy control function has completed the requested update of the non-native network access policy of the device.
Clause 5: The method according to any of clauses 1 to 4, further comprising: transmitting, to the device, a registration acceptance message, in response to determining that the first non-native network access function selected by the device for accessing the communication network supports the network slice requested by the device.
Clause 6: The method according to any of clauses 1 to 5, wherein the communication network comprises a 3GPP core network, and wherein the non-native access network comprises a non-3GPP access network.
Clause 7: The method according to clause 6, wherein the non-3GPP access network comprises a wireless local area network.
Clause 8: The method according to clause 6 or 7, wherein the non-native network access policy of the device comprises an access network discovery and selection policy or a wireless local area network selection policy.
Clause 9: The method according to any of clauses 6 to 8, wherein the access management function comprises an access and mobility management function.
Clause 10: The method according to any of clauses 6 to 9, wherein the non-native network access function comprises a non-3GPP interworking function or a trusted non-3GPP gateway function.
Clause 11: A method comprising: receiving, by a policy control function of a communication network, a request for updating a non-native network access policy of a device comprising an indication of a non-native network access function to be included in the non-native network access policy of the device; updating the non-native network access policy of the device to include the indicated non-native network access function; and transmitting, to an access management function of the communication network, an indication that the policy control function has completed the requested update of the non-native network access policy of the device.
Clause 12: The method according to clause 11, further comprising: receiving, from the access management function, a request for indicating that the policy control function has completed the requested update of the non-native network access policy of the device.
Clause 13: The method according to clause 11 or 12, further comprising: determining that there is a delay associated with the requested update of the non-native network access policy of the device; and transmitting, to the access management function, an indication of the delay of the requested update of the non-native network access policy of the device.
Clause 14: The method according to any of clauses 11 to 13, wherein the communication network comprises a 3GPP core network, and wherein the non-native access network comprises a non-3GPP access network.
Clause 15: The method according to clause 14, wherein the non-3GPP access network comprises a wireless local area network.
Clause 16: The method according to clause 14 or 15, wherein the non-native network access policy of the device comprises an access network discovery and selection policy or a wireless local area network selection policy.
Clause 17: The method according to any of clauses 14 to 16, wherein the access management function comprises an access and mobility management function.
Clause 18: The method according to any of clauses 14 to 17, wherein the non-native network access function comprises a non-3GPP interworking function or a trusted non-3GPP gateway function.
Clause 19: An apparatus comprising means for performing the method of any of clauses 1 to 18.
Clause 20: An apparatus comprising: at least one processor; and at least one memory storing instructions that, when executed by the at least one processor, cause the apparatus to perform the method according to any of clauses 1 to 18.
Clause 21: A computer program comprising instructions, which, when executed by an apparatus, cause the apparatus to perform the method according to any of clauses 1 to 18.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. Term “or” may be understood to cover also a case where both of the items separated by “or” are included. Hence, “or” may be understood as an inclusive “or” rather than an exclusive “or”.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus comprising:
at least one processor; and
at least one memory storing instructions of an access and mobility management function, the instructions, when executed by the at least one processor, causing the apparatus to perform operations, the operations comprising:
receiving, via a non-3GPP access network, a registration request message from a user equipment, the registration request message comprising one or more network slices to which the user equipment wishes to register;
determining that the non-3GPP access network does not support the one or more network slices to which the user equipment wishes to register;
transmitting, to a policy control function, a request to update policy rules of the user equipment and a request to notify the access and mobility management function when the policy control function has completed a requested updating of the policy rules of the user equipment; and
transmitting, to the user equipment, a registration reject message, in response to receiving, from the policy control function, a notification that the policy control function has completed the requested updating of the policy rules of the user equipment.

2. The apparatus according to claim 1, the operations further comprising:
determining a second non-3GPP access network that supports the one or more network slices to which the user equipment wishes to register; and
wherein the transmitting the registration request message comprises transmitting, in the registration reject message to the user equipment, an indication of the second non-3GPP access network that supports the one or more network slices to which the user equipment wishes to register.

3. (canceled)

4. The apparatus according to claim 1, wherein the non-3GPP access network comprises a trusted or untrusted non-3GPP access network.

5. The apparatus according to claim 1, wherein the policy rules of the user equipment are included in a non-3GPP access network access policy of the user equipment that comprises an access network discovery and selection policy or a wireless local area network selection policy.

6. The apparatus according to claim 1, wherein the non-3GPP access network comprises a non-3GPP interworking function or a trusted non-3GPP gateway function.

7. A method comprising:
receiving, by an access and mobility management function, via a non-3GPP access network, a registration request message from a user equipment, the registration request message comprising one or more network slices to which the user equipment wishes to register;
determining that the non-3GPP access network does not support the one or more network slices to which the user equipment wishes to register;
transmitting, to a policy control function, a request to update policy rules of the user equipment and a request to notify the access and mobility management function when the policy control function has completed a requested updating of the policy rules of the user equipment; and
transmitting, to the user equipment, a registration reject message, in response to receiving, from the policy control function, a notification that the policy control function has completed the requested updating of the policy rules of the user equipment.

8. The method according to claim 1, further comprising:
determining a second non-3GPP access network that supports the one or more network slices to which the user equipment wishes to register; and
wherein the transmitting the registration request message comprises transmitting, in the registration reject message to the user equipment, an indication of the second non-3GPP access network that supports the one or more network slices to which the user equipment wishes to register.

9. (canceled)

10. The method according to claim 7, wherein the non-3GPP access network comprises a trusted or untrusted non-3GPP access network.

11. The method according to claim 7, wherein the policy rules of the user equipment are included in a non-3GPP access network access policy of the user equipment that comprises an access network discovery and selection policy or a wireless local area network selection policy.

12. The method according to claim 7, wherein the non-3GPP access network comprises a non-3GPP interworking function or a trusted non-3GPP gateway function.

13. (canceled)

14. A non-transitory computer readable medium comprising instructions, which, when executed by a processor, cause the processor to perform operations, the operations comprising:
receiving, by an access and mobility management function, via a non-3GPP access network, a registration request message from a user equipment, the registration request message comprising one or more network slices to which the user equipment wishes to register;
determining that the non-3GPP access network does not support the one or more network slices to which the user equipment wishes to register;
transmitting, to a policy control function, a request to update policy rules of the user equipment and a request to notify the access and mobility management function when the policy control function has completed a requested updating of the policy rules of the user equipment; and
transmitting, to the user equipment, a registration reject message, in response to receiving, from the policy control function, a notification that the policy control function has completed the requested updating of the policy rules of the user equipment.

15. The non-transitory computer readable medium according to claim 14, wherein the operations further comprising:
determining a second non-3GPP access network that supports the one or more network slices to which the user equipment wishes to register; and
wherein the transmitting the registration request message comprises transmitting, in the registration reject message to the user equipment, an indication of the second non-3GPP access network that supports the one or more network slices to which the user equipment wishes to register.

16. The non-transitory computer readable medium according to claim 15, wherein the second non-3GPP access network comprises a trusted or untrusted non-3GPP access network.

17. The non-transitory computer readable medium according to claim 15, wherein the second non-3GPP access network comprises a non-3GPP interworking function or a trusted non-3GPP gateway function.

18. The non-transitory computer readable medium according to claim 14, wherein the non-3GPP access network comprises a trusted or untrusted non-3GPP access network.

19. The non-transitory computer readable medium according to claim 14, wherein the policy rules of the user equipment are included in a non-3GPP access network access policy of the user equipment that comprises an access network discovery and selection policy or a wireless local area network selection policy.

20. The non-transitory computer readable medium according to claim 14, wherein the non-3GPP access network comprises a non-3GPP interworking function or a trusted non-3GPP gateway function.

21. The apparatus according to claim 2, wherein the second non-3GPP access network comprises a trusted or untrusted non-3GPP access network.

22. The apparatus according to claim 2, wherein the second non-3GPP access network comprises a non-3GPP interworking function or a trusted non-3GPP gateway function.

23. The method according to claim 7, wherein the second non-3GPP access network comprises a trusted or untrusted non-3GPP access network.
